(19) United States
(12) Patent Application Publication
(10) Pub. No.: US 2019/0348870 A1
(43) Pub. Date: Nov. 14, 2019

(54) ELECTRONIC DEVICE, POWER TRANSMISSION DEVICE, AND POWER TRANSMISSION SYSTEM

(71) Applicant: KYOCERA Corporation, Kyoto (JP)

(72) Inventors: Tomoaki MIWA, Fujisawa-shi, Kanagawa (JP); Tetsushi WAKASA, Yokohama-shi, Kanagawa (JP)

(73) Assignees: KYOCERA Corporation, Kyoto (JP); KYOCERA Corporation, Kyoto (JP)

(21) Appl. No.: 16/483,598

(22) PCT Filed: Jan. 23, 2018
(86) PCT No.: PCT/JP2018/001910

§ 371 Date: Aug. 5, 2019

(30) Foreign Application Priority Data
Feb. 6, 2017 (JP) 2017-019421

(51) Int. Cl. H02J 50/20; H02J 50/80; H02J 50/40; H02J 50/90; G08B 7/06

(52) U.S. Cl. CPC H02J 50/20; H02J 50/80; H02J 7/025; H02J 50/90; G08B 7/06; H02J 50/40

(57) ABSTRACT

An electronic device is provided with a power receiving unit for receiving wireless power, a control unit for determining an amount of power received by the power receiving unit, and a notification unit for providing a notification to facilitate the movement of the electronic device according to the amount of power received.

### CROSS-REFERENCE TO RELATED APPLICATION

This application claims priority to and benefit of Japanese Patent Application No. 2017-019421 filed Feb. 6, 2017, the entire contents of which are incorporated herein by reference.

### TECHNICAL FIELD

The present disclosure relates to an electronic device, a power transmission device and a power transmission system.

### BACKGROUND

A method for using electromagnetic waves to supply power to an electronic device is conventionally known. For example, JP2014-223018 (PTL 1) discloses a power transmitter which uses microwaves to supply power to a device.

### CITATION LIST

### Patent Literature

PTL 1: JP2014-223018A

### SUMMARY

The electronic device according to one of the disclosed aspects is provided with a power receiving unit for receiving wireless power, a control unit for determining an amount of power received by the power receiving unit, and a notification unit for providing a notification to facilitate the movement of the electronic device according to the amount of power received.

The power transmission device according to one of the disclosed aspects is provided with a power transmission unit for transmitting wireless power to a plurality of electronic devices, a control unit for determining transmission information relating to the transmission of the wireless power to the respective plurality of electronic devices, and a communication unit for sending a notification to facilitate the movement to the plurality of electronic devices in accordance with the transmission information.

The power transmission system according to one of the disclosed aspects is provided with the power transmission device and the electronic device. The power transmission device transmits the wireless power. The electronic device receives the wireless power from the power transmission device and provides a notification to facilitate the movement of an own device in accordance with the amount of power received of the wireless power.

### BRIEF DESCRIPTION OF THE DRAWINGS

In the accompanying drawings:

FIG. 1 is diagram illustrating a schematic configuration of a power transmission system according to an embodiment;

FIG. 2 is a functional block diagram illustrating a schematic configuration of the power transmission system of FIG. 1;

FIG. 3 is a sequence diagram illustrating an example of a power transmission procedure performed by the power transmission system of FIG. 2;

FIG. 4 is a flowchart illustrating an example of the process executed by an electronic device of FIG. 2;

FIG. 5 is a sequence diagram illustrating another example of power transmission procedure performed by the power transmission system of FIG. 2;

FIG. 6 is a flowchart illustrating another example of the process executed by the electronic device of FIG. 2;

FIG. 7 is a sequence diagram illustrating an example of a power transmission procedure performed by the power transmission system according to an embodiment;

FIG. 8 is a flowchart illustrating an example of the process executed by the electronic device in the power transmission system according to an embodiment; and

FIG. 9 is a flowchart illustrating an example of the process executed by the power transmission device in the power transmission system according to an embodiment.

### DETAILED DESCRIPTION

In the transmission of power by a power transmitter, if a receiver can efficiently receive the power transmitted from the power transmitter, utility is improved. An object of the present disclosure is to provide an electronic device, a power transmission device and a power transmission system, with improved utility.

Hereinafter, embodiments according of the present disclosure will be described with reference to the drawings.

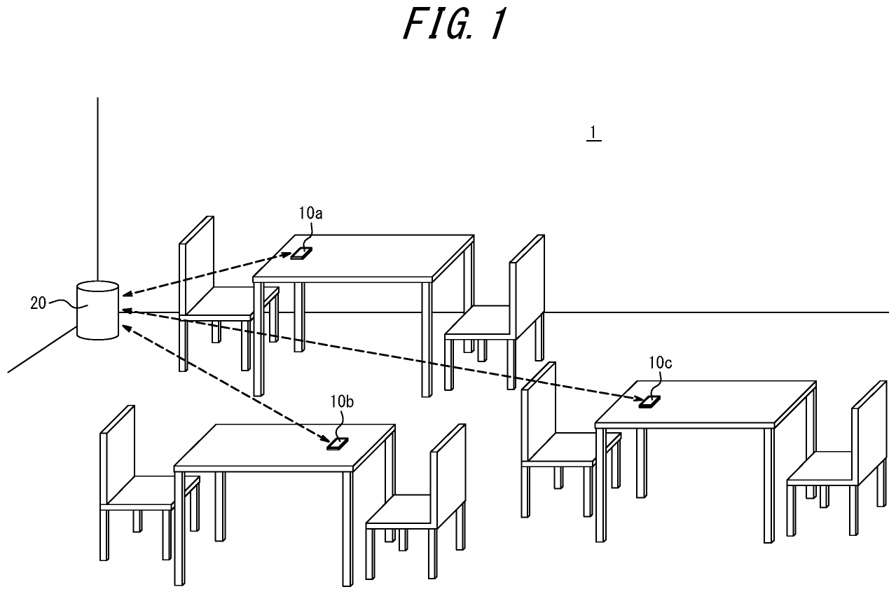

FIG. 1 is diagram illustrating a schematic configuration of a power transmission system according to an embodiment. A power transmission system 1 is provided with a plurality of electronic devices 10a, 10b and 10c and a power transmission device 20. In FIG. 1, three mobile phones are illustrated as an example of the plurality of electronic devices 10a, 10b and 10c. In the description, when the plurality of electronic devices 10a, 10b and 10c are not distinguished from each other, they are collectively referred to as an electronic device 10. In FIG. 1, a power transmission system 1 including three electronic devices 10 is illustrated as one example, but the number of electronic devices 10 included in the power transmission system 1 is not limited to three. The power transmission system 1 may include one, two, or four or more of the electronic devices 10.

The power transmission system 1 can be realized, for example, in a café or the like. When the power transmission system 1 is realized in a cafe, the power transmission device 20 is provided by, for example, the operator who operates the cafe. A mobile phone, which is the electronic device 10, is owned by a user/customer visiting the cafe. When the user visits the cafe, the electronic device 10 can receive a supply of power from the power transmission device 20 in the cafe. Due to the supply of power, the electronic device 10 can charge a power storage unit (for example, a battery) provided therein.

In FIG. 1, the mobile phone is illustrated as an example of the electronic device 10, but the electronic device 10 is not limited to a mobile phone, and may be any electronic device which can be driven based on power transmitted from the power transmission device 20.

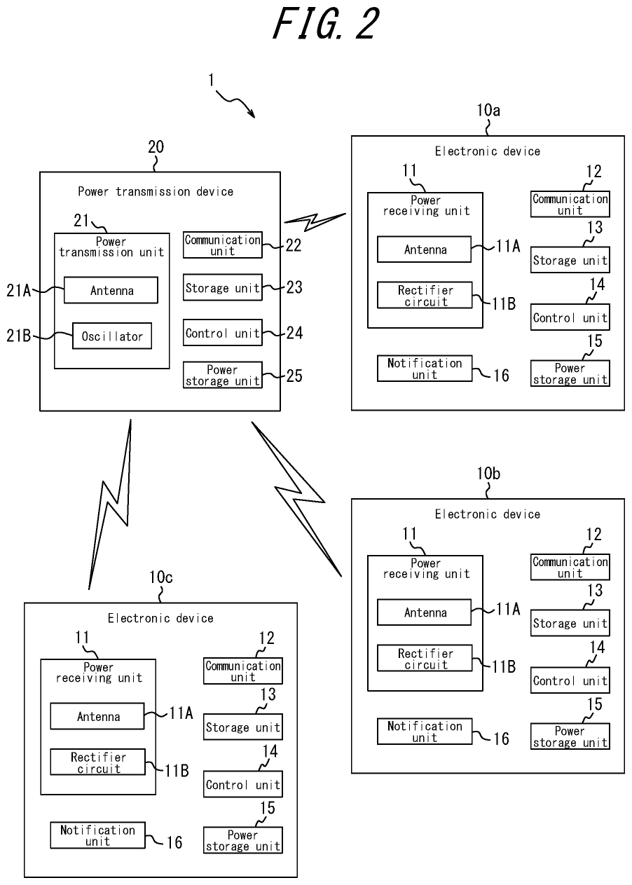

FIG. 2 is a functional block diagram illustrating a schematic configuration of the power transmission system of FIG. 1. The power transmission system 1, as described above, includes the electronic devices 10a, 10b and 10c, and the power transmission device 20.

The electronic device 10 receives wireless power from the power transmission device 20. Specifically, the electronic device 10 receives electromagnetic waves for power supply from the power transmission device 20. The electronic device 10 converts the received electromagnetic waves to DC power. Thereby, the electronic device 10 receives wireless power from the power transmission device 20.

The electronic device 10 may be driven by the received power. The electronic device 10 is provided with a power receiving unit 11, a communication unit 12, a storage unit 13, a control unit 14, a power storage unit 15, and a notification unit 16.

The power receiving unit 11 receives the wireless power. Specifically, the power receiving unit 11 receives the wireless power by generating power based on the electromagnetic waves received from the outside, based on control by the control unit 14. The power receiving unit 11 supplies the generated power to the electronic device 10.

The power receiving unit 11 is provided with an antenna 11A and a rectifier circuit 11B. The antenna 11A receives electromagnetic waves from the power transmission device 20. The rectifier circuit 11B converts the electromagnetic waves received by the antenna 11A to DC power. The rectifier circuit 11B supplies the converted DC power to the electronic device 10.

The communication unit 12 performs wireless communication with external devices based on control by the control unit 14. The communication unit 12 communicates with, for example, the power transmission device 20. The communication unit 12 may also communicate with another electronic device 10. The electronic device 10 may also use the antenna 11A, in place of the communication unit 12, to perform wireless communication. The communication unit 12 may transmit a power transmission request requesting power transmission to the power transmission device 20. The communication unit 12 may also receive information relating to the amount of power transmitted from the power transmission device 20 to the respective device.

The storage unit 13 may be configured as a semiconductor memory, a magnetic memory or the like. The storage unit 13 stores various information and programs for operating the electronic device 10 or the like. The storage unit 13 may also function as a work memory.

The control unit 14 is a processor that controls and manages the entirety of the electronic device 10 including each functional block of the electronic device 10. The control unit 14 is configured as a processor such as a Central Processing Unit (CPU) that executes a program prescribing control procedures or a dedicated processor specialized for the processing of each function.

The control unit 14 determines the amount of power received in the power receiving unit 11 of the electronic device 10. The control unit 14, via the notification unit 16, provides a notification to prompt movement of the respective device according to the amount of power received. The details of the processes executed by the control unit 14 will be described hereafter.

The power storage unit 15 is electrically connected to the power receiving unit 11. The power storage unit 15 can store the power (hereinafter, referred to as “surplus power”) which was not consumed by the electronic device 10 from the power received by the power receiving unit 11. The power stored by the power storage unit 15 may be supplied to the electronic device 10, for example, when the electronic device 10 cannot receive the supply of wireless power from the power transmission device 20.

The notification unit 16 notifies information by sound, vibration, images or the like. The notification unit 16 may be provided with a speaker, a vibrator, and a display device. The display device may be, for example, a liquid crystal display (LCD), an organic EL display (OELD), an inorganic EL display (IELD) or the like. The notification unit 16 may provide the notification to prompt movement of the electronic device according to the amount of power received, based on control by the control unit 14.

The power transmission device 20 is, for example, a home gateway, a wireless power transmission system or the like, and is installed indoors, for example, inside of a café. The power transmission device 20 transmits wireless power to the electronic device 10.

Specifically, the power transmission device 20 generates electromagnetic waves for the power supply. The power transmission device 20 transmits the generated electromagnetic waves to the electronic device 10 installed, for example, in the same room.

The power transmission device 20 is provided with a power transmission unit 21, a communication unit 22, a storage unit 23, a control unit 24, and a power storage unit 25.

The power transmission unit 21 transmits the wireless power. Specifically, the power transmission unit 21 transmits the wireless power, for example, by outputting the power supplied from a power source, such as power distribution equipment or the like, as electromagnetic waves, based on control by the control unit 24.

The power transmission unit 21 is provided with an antenna 21A and an oscillator 21B. The oscillator 21B transmits wireless power by sending electromagnetic waves from the antenna 21A based on power supplied from the power source.

The communication unit 22 performs wireless communication with external devices based on control by the control unit 24. In the present embodiment, the communication unit 22 communicates with the electronic device 10. The power transmission device 20 may also use the antenna 21A, in place of the communication unit 22, to perform wireless communication. The communication unit 22 may, for example, receive a power transmission request sent from the electronic device 10. The communication unit 22 may also send information relating to the amount of power transmitted to the electronic device 10 to the electronic device 10.

The storage unit 23 may be configured as a semiconductor memory, a magnetic memory or the like. The storage unit 23 stores various information and programs for operating the power transmission device 20 or the like. The storage unit 23 may also function as a work memory.

The control unit 24 is a processor that controls and manages the entirety of the power transmission device 20 including each functional block of the power transmission device 20. The control unit 24 is configured as a processor such as a CPU that executes a program prescribing control procedures or a dedicated processor specialized for the processing of each function.

The power storage unit 25 can store the power supplied from the power source.

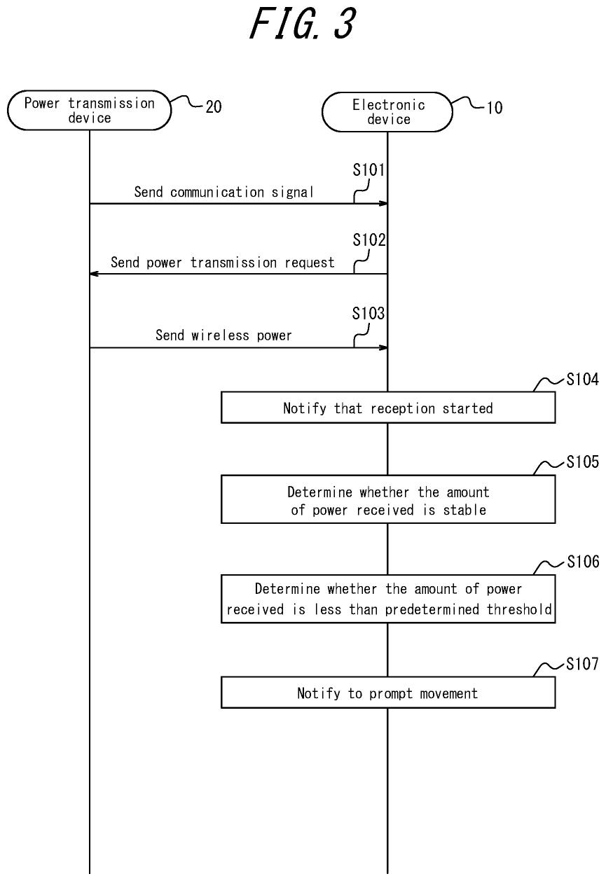

Next, an example of the power transmission procedure performed by the power transmission system 1 will be described with reference to FIG. 3.

The power transmission device 20 sends a communication signal for indicating the presence of the power transmission device 20 (Step S101). The communication signal may be, for example, a beacon packet or the like. When a user having the electronic device 10 visits a store in which the power transmission device 20 is installed, the electronic device 10 receives the communication signal sent from the power transmission device 20. In this manner, the electronic device 10 can recognize that power can be received from the power transmission device 20.

Upon receipt of the communication signal sent from the power transmission device 20 in Step S101, the electronic device 10 sends a power transmission request which is a signal requesting the supply of power (Step S102).

Upon receipt of the power transmission request, the power transmission device 20 recognizes that the electronic device 10 is present in the direction from which the power transmission request was sent, and transmits the wireless power in that direction (Step S103).

Upon receipt of wireless power from the power transmission device 20, the notification unit 16 of the electronic device 10 notifies that power reception has started (Step S104). The notification by the notification unit 16 may be, for example, a vibration. Due to the notification by the notification unit 16, the user who is the owner of the electronic device 10 can recognize that the electronic device 10 has started to receive power.

Upon starting to receive wireless power, the electronic device 10 determines whether the amount of power received is stable (Step S105). The electronic device 10 can determine that the amount of power received is stable, for example, when the fluctuation range of the amount of power received is within a predetermined range for a predetermined time. For example, when the owner is not seated and is moving within a store, the positional relationship of the electronic device 10 relative to the power transmission device 20 changes. In this case, it is assumed that the amount of power received by the electronic device 10 is not stable. Therefore, the electronic device 10 can estimate whether the user is seated by whether the amount of power received is stable.

Upon determining in Step S105 that the amount of power received was stable, the electronic device 10 determines whether the amount of power received is less than the predetermined threshold (Step S106). The predetermined threshold may be a threshold which enables determination of whether the electronic device 10 has received the wireless power from the power transmission device 20 at an efficiency of a predetermined standard or higher. The predetermined threshold may be, for example, stored beforehand in the storage unit 13. The predetermined threshold may also be, for example, appropriately determined by the control unit 14.

When it is determined in Step S106 that the amount of power received is less than the predetermined threshold, the electronic device 10 can determine that the power reception efficiency is lower than the predetermined standard. In this case, the electronic device 10 provides the notification from the notification unit 16 to prompt movement of the electronic device 10 (Step S107). The notification to prompt movement may be, for example, a vibration, a display on a display device or the like. The user can recognize that the power reception efficiency is poor at the location in which the electronic device 10 was placed due to the notification to prompt movement, and, for example, can move the location of the electronic device 10, or can hold the electronic device 10 and change seats to a vacant seat when there is a vacant seat.

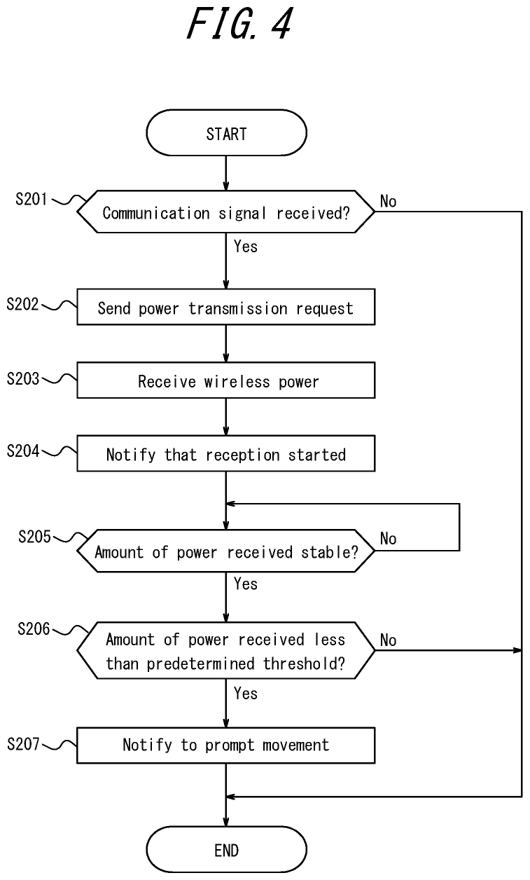

FIG. 4 is a flowchart illustrating an example of the process executed by the electronic device 10. The electronic device 10 can repeatedly execute the flowchart shown in FIG. 4 in a regular, irregular, or continuous manner.

The electronic device 10 determines whether the communication signal was received at the communication unit 12 from the power transmission device 20 (Step S201).

When it is determined that the communication signal has not been received at the communication unit 12 (No in Step S201), the electronic device 10 can determine that there is no power transmission device 20 in the vicinity which can supply wireless power to the electronic device 10. In this case, the electronic device 10 terminates this flow.

When it is determined that the communication signal has been received at the communication unit 12 (Yes in Step S201), the electronic device 10 sends the power transmission request of the wireless power (Step S202).

The electronic device 10 receives the wireless power sent from the power transmission device 20 in response to the power transmission request of Step S202 (Step S203).

Upon starting to receive wireless power, the electronic device 10 notifies the notification unit 16 that reception has started (Step S204).

The electronic device 10 determines whether the amount of wireless power received from the power transmission device 20 is stable (Step S205).

When it is determined that the amount of power received is not stable (No in Step S205), the electronic device 10 can estimate that the user is not yet seated. In this case, the electronic device 10 repeatedly executes Step S205 until the amount of power received is stable.

When it is determined that the amount of power received is stable (Yes in Step S205), the electronic device 10 determines whether the stable amount of power received is less than the predetermined threshold (Step S206).

When it is determined that the amount of power received is equal to or greater than the predetermined threshold (No in Step S206), the electronic device 10 determines that the power reception efficiency is of a predetermined standard or higher. In this case, the electronic device 10 terminates this flow. In this case, the electronic device 10 may notify, via the notification unit 16, that the reception is poor. Due to this notification, the user is able to recognize that the reception is satisfactory, and that it is not necessary to move to an empty seat.

When it is determined that the amount of power received is less than the predetermined threshold (Yes in Step S206), the electronic device 10 provides the notification, via the notification unit 16, to prompt movement of the electronic device 10 (Step S207). Due to this notification, the user is able to recognize that the power reception efficiency in the seat in which the user is seated is poor, and is able to recognize that it is preferable to change the location of the electronic device 10.

In this manner, in the power transmission system 1 according to the present embodiment, the electronic device 10 determines the power reception efficiency at the location in which the electronic device 10 is disposed according to the amount of power received. For example, when the amount of power received is less than the predetermined threshold, the electronic device 10 provides the notification to prompt movement. Due to this notification, a user who is the owner of the electronic device 10 can move the location of the electronic device 10, and can change seats to a vacant seat. In this manner, the power reception efficiency of the electronic device 10 may be easily maintained at a predetermined standard or higher. Therefore, the power supply is efficiently provided from the power transmission device 20 to the electronic device 10, and thus, according to the power transmission system 1, utility can be improved.

In the aforementioned embodiment, the electronic device 10 may also determine the appropriate aforementioned predetermined threshold in accordance with the amount of power transmitted from the power transmission device 20. For example, when the aforementioned predetermined threshold is set to a predetermined value, the smaller the amount of power transmitted from the power transmission device 20 to the electronic device 10, the more the amount of power received by the electronic device 10 tends to decrease. Therefore, the amount of power received by the electronic device 10 easily becomes less than the predetermined threshold. However, when the amount of power transmitted is low, it is difficult to increase the amount of power received even if the electronic device 10 is moved. Due to the electronic device 10 determining the predetermined threshold in accordance with the amount of power transmitted from the power transmission device 20, it becomes easy to evaluate the power reception efficiency of the electronic device 10. Therefore, it becomes easy for the electronic device 10 to more accurately evaluate whether movement of the electronic device 10 will increase the amount of power received.

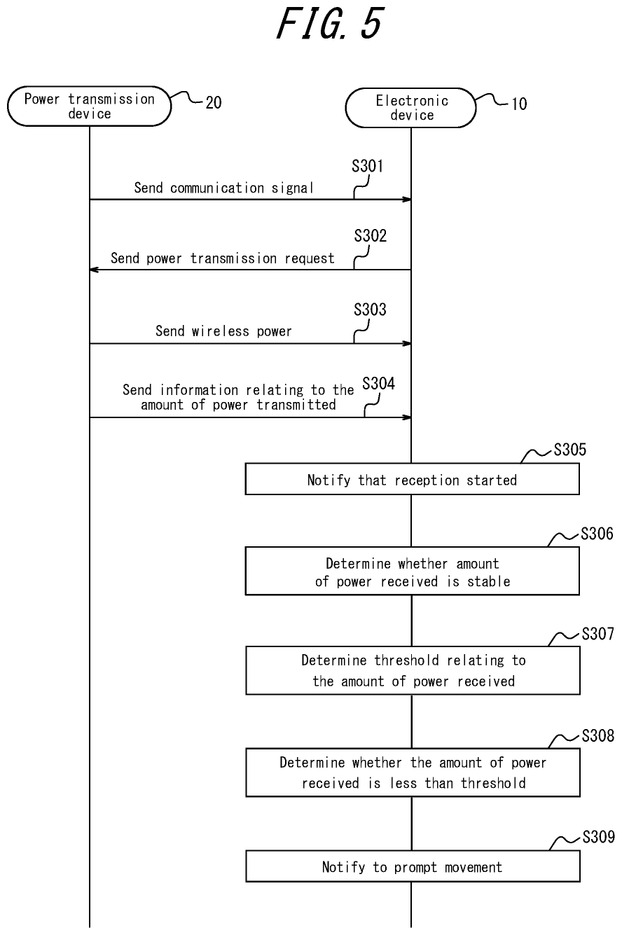

Details of the process in the case when the electronic device 10 determines the predetermined threshold according to the amount of power transmitted from the power transmission device 20 are described with reference to FIG. 5.

The power transmission device 20 sends a communication signal to indicate the presence of the power transmission device 20 (Step S301). Upon receipt of the communication signal sent from the power transmission device 20, the electronic device 10 sends a power transmission request (Step S302).

Upon receipt of the power transmission request, the power transmission device 20 transmits the wireless power in the direction from which the power transmission request was sent (Step S303). Moreover, the power transmission device 20 sends information relating to the amount of power transmitted to the electronic device 10 from the communication unit 22 (Step S304).

Upon receipt of wireless power from the power transmission device 20, the electronic device 10 notifies, via the notification unit 16, that the reception started (Step S305). Upon starting to receive wireless power, the electronic device 10 determines whether the amount of power received was stable (Step S306).

The electronic device 10 determines the threshold relating to the amount of power received based on the information relating to the amount of power transmitted from the power transmission device 20 in Step S304 (Step S307). The electronic device 10 stores in the storage unit 13, for example, a formula for calculating the threshold relating to the amount of power received based in the amount of power transmitted, and may determine the threshold relating to the amount of power received using the formula. The electronic device 10 stores a table which indicates, for example, the relationship between the threshold relating to the amount of power received and the amount of power transmitted, and may determine the threshold relating to the amount of power received with reference to the table. The threshold relating to the amount of power received may be determined, for example, as a predetermined ratio with respect to the amount of power transmitted. The threshold relating to the amount of power received may be determined, for example, so as to have a positive correlation to the amount of power transmitted. For example, the threshold relating to the amount of power received may be determined to be higher as the amount of power transmitted increases.

Upon determining in Step S306 that the amount of power received is stable, the electronic device 10 determines whether the amount of power received is less than the threshold determined in Step S307 (Step S308)

When it is determined in Step S308 that the amount of power received is less than the threshold, the electronic device 10 provides a notification, via the notification unit 16, to prompt movement of the electronic device 10 (Step S309).

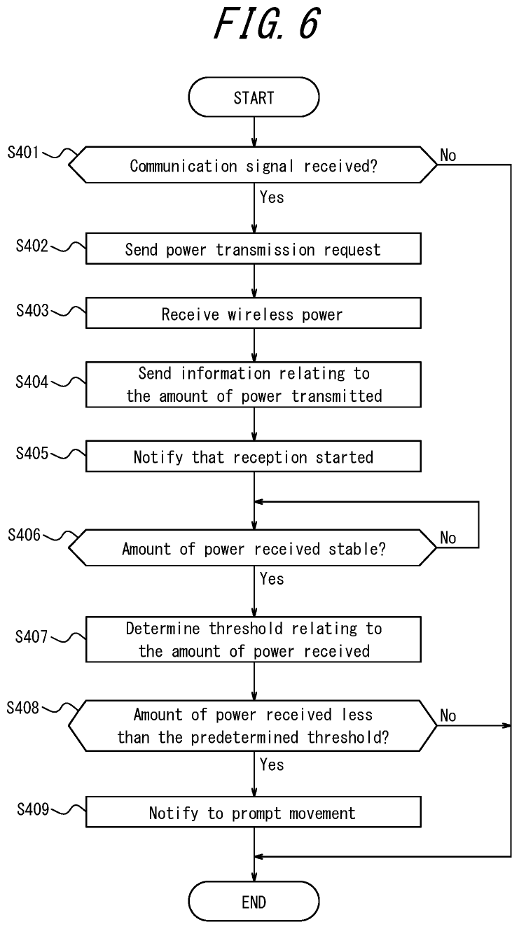

FIG. 6 is a flowchart illustrating another example of the process executed by the electronic device 10, and is flowchart illustrating an example of the process performed by the electronic device 10 corresponding to the sequence diagram of FIG. 5.

The electronic device 10 determines whether the communication signal was received from the power transmission device 20 at the communication unit 12 (Step S401).

When it is determined that the communication signal has not been received at the communication unit 12 (No in Step S401), the electronic device 10 terminates this flow.

When it is determined that the communication signal has been received at the communication unit 12 (Yes in Step S401), the electronic device 10 sends the power transmission request for wireless power (Step S402).

The electronic device 10 receives the wireless power sent from the power transmission device 20 in response to the power transmission request of Step S402 (Step S403).

The electronic device 10 receives the information relating to the amount of power transmitted, sent from the power transmission device 20, at the communication unit 12 (Step S404).

Upon starting to receive wireless power, the electronic device 10 notifies, via the notification unit 16, that the reception has started (Step S405).

The electronic device 10 determines whether the amount of wireless power received from the power transmission device 20 was stable (Step S406).

When it is determined that the amount of power received is not stable (No in Step S406), the electronic device 10 repeatedly executes Step S406 until the amount of power received is stable.

When it is determined that the amount of power received was stable (Yes in Step S406), the electronic device 10 determines the threshold relating to the amount of power received based on the information relating to the amount of power transmitted, which was received in Step S404 (Step S407).

The electronic device 10 determines whether the amount of power received is less than the threshold determined in Step S407 (Step S408).

When it is determined that the amount of power received is greater than or equal to the threshold (No in Step S408), the electronic device 10 terminates this flow.

When it is determined that the amount of power received is less than the threshold (Yes in Step S408), the electronic device 10 provides a notification, via the notification unit 16, to prompt movement of the electronic device 10 (Step S409).

In this manner, due to the electronic device 10 determining the predetermined threshold according to the amount of power transmitted from the power transmission device 20, and using the determined threshold to determine whether to provide the notification, the power transmission system 1 can evaluate the power reception efficiency in accordance with the amount of power transmitted. Therefore, it becomes easy for the power transmission system 1 to more accurately evaluate whether movement of the electronic device 10 increases the amount of power received of the electronic device 10 compared to when a uniform threshold is used.

In the aforementioned embodiment, the case when the electronic device 10 determines whether the notification to prompt movement of the electronic device is provided was described. Hereinafter, an embodiment in which the power transmission device 20 determines whether the notification to prompt movement of the electronic device 10 is provided will be described. The functional blocks of the power transmission system 1 according to the embodiment described hereinafter are the same as those according to the aforementioned embodiment, i.e., the functional blocks are the same as those shown in FIG. 2, thus, a detailed description thereof has been omitted.

In an embodiment, the control unit 24 of the power transmission device 20 determines information (hereinafter, referred to as the “transmission information”) relating to the transmission of wireless power to the electronic device 10. The transmission information may include, for example, the power transmission efficiency of the wireless power from the power transmission device 20 to each electronic device 10. The power transmission efficiency is indicated by the ratio of the amount of wireless power received by the electronic device 10 with respect to the amount of wireless power transmitted by the power transmission device 20.

The power transmission device 20, for example, obtains, via the communication unit 22, information relating to the amount of wireless power received by each electronic device 10a, 10b and 10c respectively from each electronic device 10a, 10b and 10c. The control unit 24 of the power transmission device 20 calculates the power reception efficiency of the wireless power for each electronic device 10a, 10b and 10c based on the amount of wireless power transmitted to and the amount of power received from each electronic device 10a, 10b and 10c.

The control unit 24 determines the electronic device 10 for which to prompt movement based on the calculated power reception efficiency. The control unit 24 determines the electronic device 10 in which, for example, the power reception efficiency is less than a predetermined threshold which was stored beforehand in the storage unit 23, as the electronic device 10 for which to prompt movement. The control unit 24 sends a notification to prompt movement, via the communication unit 22, to the electronic device 10 which was determined to be the electronic device 10 for which to prompt movement.

The electronic device 10 which receives the notification from the power transmission device 20 to prompt movement provides a notification to prompt movement of the electronic device 10 via the notification unit 16.

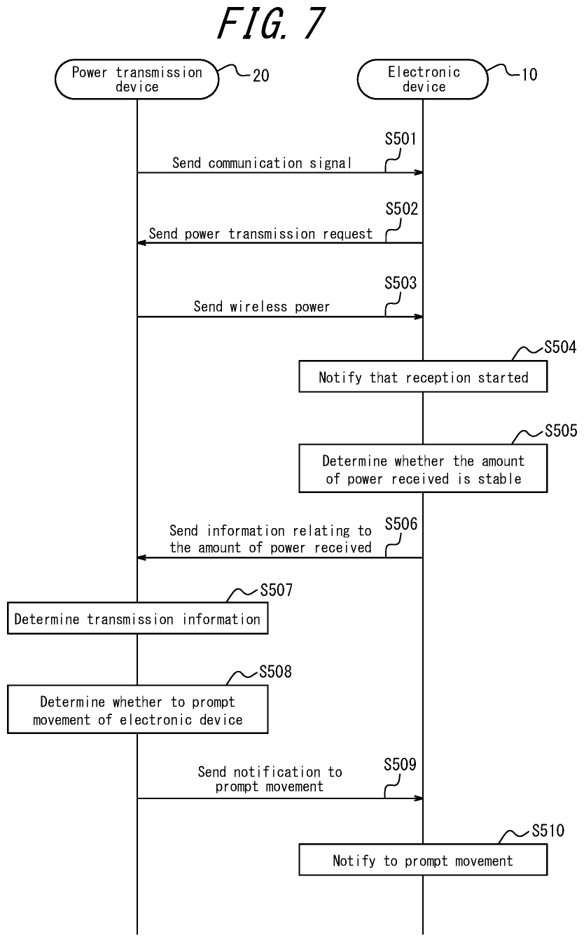

FIG. 7 is a sequence diagram illustrating an example of the power transmission procedure performed by the power transmission system 1 according to an embodiment.

First, the power transmission device 20 sends a communication signal indicating the presence of the power transmission device 20 (Step S501). Upon receipt of the communication signal sent from the power transmission device 20, the electronic device 10 sends a power transmission request (Step S502).

Upon receipt of the power transmission request, the power transmission device 20 transmits wireless power in the direction from which the power transmission request was sent (Step S503).

Upon receipt of the wireless power from the power transmission device 20, the electronic device 10 notifies, via the notification unit 16, that reception has started (Step S504). Upon starting to receive the wireless power, the electronic device 10 determines whether the amount of power received is stable (Step S505).

Upon determining that the amount of power received is stable in

Step S505, the electronic device 10 sends information relating to the amount of power received from the communication unit 12 to the power transmission device 20 (Step S506).

Upon obtaining the information relating to the amount of power received via the communication unit 22, the power transmission device 20 determines the transmission information in the control unit 24 (Step S507). The control unit 24 calculates the power transmission efficiency, for example, as stated above.

The power transmission device 20 determines whether to prompt movement of the electronic device 10 based on the transmission information determined in Step S507 (Step S508). The power transmission device 20 may determine to prompt movement of the electronic device 10, for example, when the power reception efficiency is less than the predetermined threshold.

When it is determined to prompt movement of the electronic device 10 in Step S508, the power transmission device 20 sends a notification, via the communication unit 22, to prompt movement of the electronic device 10 (Step S509).

Upon receipt of the notification to prompt movement from the power transmission device 20, the electronic device 10 provides, via the notification unit 16, a notification to prompt movement of the electronic device 10 (Step S510).

Each time the power transmission device 20 receives, from the electronic device 10, information relating to the amount of power received, it may determine whether to prompt movement of the electronic device 10 in Step S507 and Step S508.

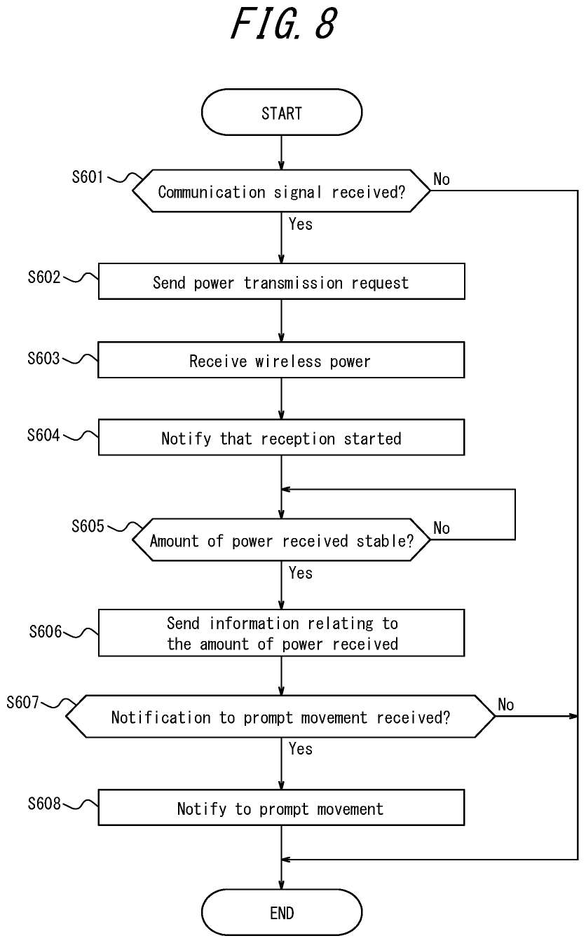

FIG. 8 is a flowchart illustrating an example of the process executed by the electronic device 10 in the power transmission system 1 according to one of the disclosed embodiments, and is a flowchart illustrating an example of the process by the electronic device 10 corresponding to the sequence diagram of FIG. 7.

The electronic device 10 determines whether a communication signal was received at the communication unit 12 from the power transmission device 20 (Step S601).

When it is determined that the communication signal has not been received at the communication unit 12 (No in Step S601), the electronic device 10 terminates this flow.

When it is determined that the communication signal has been received at the communication unit 12, (Yes in Step S601), the electronic device 10 sends a power transmission request for wireless power (Step S602).

The electronic device 10 receives wireless power sent from the power transmission device 20 (Step S603) in response to the power transmission request of Step S602.

Upon starting to receive wireless power, the electronic device 10 notifies, via notification unit 16, that the reception started (Step S604).

The electronic device 10 determines whether the amount of wireless power received from the power transmission device 20 was stable (Step S605).

When it is determined that the amount of power received is not stable (No in Step S605), the electronic device 10 repeatedly executes Step S605 until the amount of power received is stable.

When it is determined that the amount of power received is stable (Yes in Step S605), the electronic device 10 sends information relating to the amount of power received to the power transmission device 20 (Step S606).

The electronic device 10 determines whether a notification to prompt movement has been received from the power transmission device 20 (Step S607).

When it is determined that a notification to prompt movement has not been received (No in Step S607), the electronic device 10 terminates this flow.

When the notification to prompt movement has been received (Yes in Step S607), the electronic device 10 provides a notification to prompt movement of the electronic device 1 via the notification unit 16 (Step S608).

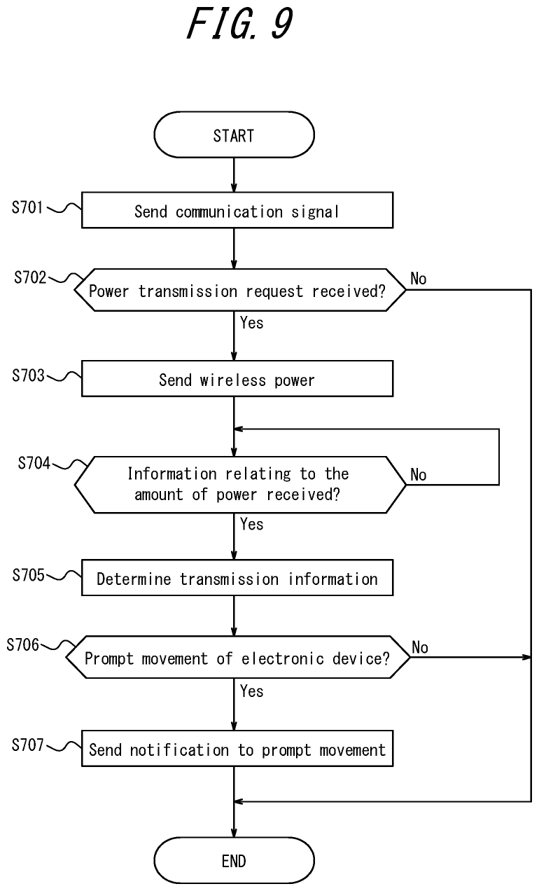

FIG. 9 is a flowchart illustrating an example of the process executed by the power transmission device 20 in the power transmission system 1 according to an embodiment, and is a flowchart illustrating an example of the process performed by the power transmission device 20 corresponding to the sequence diagram of FIG. 7.

The power transmission device 20 sends a communication signal from the communication unit 22 (Step S701).

The power transmission device 20 determines whether a power transmission request was received at the communication unit 22 from the electronic device 10 (Step S702).

When it is determined that the power transmission request was not received (No in Step S702), the power transmission device 20 terminates this flow.

When it is determined that the power transmission request was received (Yes in Step S702), the power transmission device 20 transmits the wireless power in the direction from which the power transmission request was received (Step S703).

The power transmission device 20 determines whether information relating to the amount of power received was received from the electronic device 10 (Step S704).

When it is determined that information relating to the amount of power received was not received (No in Step S704), the power transmission device 20 repeatedly executes Step S704 until information relating to the amount of power received is received.

When it is determined that the information relating to the amount of power received was received (Yes in Step S704), the power transmission device 20 determines transmission information based on the amount of wireless power transmitted to the electronic device 10 and the amount of power received (Step S705).

The power transmission device 20 determines whether to promote movement of the electronic device 10 based on the transmission information determined in Step S705 (Step S706).

When it is determined to not prompt movement of the electronic device 10 (No in Step S706), the power transmission device 20 terminates this flow. In this case, the power transmission device 20 may also send a notification to the electronic device 10 that movement is unnecessary. In this case, the electronic device 10 which received the notification that movement is unnecessary may be notified that the movement is unnecessary via the notification unit 16. In this manner, the owner of the electronic device 10 can recognize that the reception conditions are satisfactory, and that movement is unnecessary.

When it is determined to promote movement of the electronic device 10 (Yes in Step S706), the power transmission device 20 sends information to prompt movement to the electronic device 10 (Step S707).

In this manner, in the power transmission system 1 according to an embodiment, the electronic device 10 for which the reception conditions are poor provides the notification to promote movement in accordance with the transmission information determined by the control unit 24 of the power transmission device 20. Due to this notification, a user who is the owner of the electronic device 10 can change the position of the electronic device 10, and can change seats to a vacant seat. Therefore, the power reception efficiency of the electronic device 10 may be easily maintained at a predetermined standard or higher. Therefore, a power supply is efficiently provided from the power transmission device 20 to the electronic device 10, thus, the power transmission system 1 can improve utility.

In an embodiment, the power transmission device 20 may also send, to the electronic device 10, a notification to promote movement and information relating to a recommended movement destination (location). The information relating to a recommended movement destination may be, for example, the information relating to a table number associated with a recommended table in the store, and may be, for example, a floor plan (map) of a store indicating the location of the recommended table in the store.

At this time, it may also be recommended that the power transmission device 20 is moved, for example, to a location which is capable of receiving the wireless power from another power transmission device. For example, it is assumed that the store consists of 2 floors or more, and the power transmission device 20 is installed on each floor. In this case, for example, the power transmission device 20 may also recommend moving to a different floor. For example, when the power transmission device 20 is transmitting the wireless power to a plurality of electronic devices 10, and there is no margin to send the wireless power to further electronic devices 10, it may be recommended to move to a different floor.

When the position of the electronic device 10 was moved based on the notification to promote movement, the power transmission device 20 may also send an electronic coupon (discount coupon) which can be used in a café or the like in which the power transmission device 20 was disposed with respect to the electronic device 10. The power transmission device 20 determines whether the location of the electronic device 10 was moved based on, for example, the direction of the power transmission request received from the electronic device 10. Due to the power transmission device 20 sending an electronic coupon, the owner of the electronic device 10 may easily prompt movement of the electronic device 10. Furthermore, due to the power transmission device 20 sending an electronic coupon, it is anticipated that dissatisfaction which may be felt by the owner of the electronic device 10 can be easily eliminated.

Although this disclosure has been described with reference to drawings and examples, it should be noted that those skilled in the art can easily create variations and perform modifications based on the disclosure. Accordingly, it should be noted that these variations and modifications are included in the scope of the disclosure. For example, the functions included in the means and the steps, for example, are rearrangeable as long as the functions are logically consistent with each other, and a plurality of means and steps may be combined together or divided.

The power transmission system 1 according to the aforementioned embodiments may be realized in, in addition to the aforementioned cafe, a food and beverage establishment such as a restaurant. The power transmission system 1 in accordance with the disclosed embodiments may be realized in any other facility.

### REFERENCE SIGNS LIST

1 power transmission system

10, 10a, 10b, 10c electronic device

11 power receiving unit

11A, 21A antenna

11B rectifier circuit

12 communication unit

13 storage unit

14 control unit

15 power storage unit

16 notification unit

20 power transmission device

21 power transmission unit

21B oscillator

22 communication unit

23 storage unit

24 control unit

25 power storage unit

1. An electronic device comprising:
a power receiving unit for receiving wireless power,
a control unit for determining an amount of power received by the power receiving unit, and
a notification unit for providing a notification to prompt movement of the electronic device according to the amount of power received.

2. The electronic device according to claim 1, wherein
the control unit determines whether the amount of power received is less than a predetermined threshold, and
the notification unit provides the notification when the amount of power received is less than the predetermined threshold.

3. The electronic device according to claim 2, further comprising
a communication unit for communicating with a power transmission device that transmits the wireless power, wherein
the communication unit obtains information relating to an amount of power transmitted from the power transmission device to the electronic device, and
the predetermined threshold is determined based on the amount of power transmitted.

4. The electronic device according to claim 1, wherein the control unit performs the determination when the amount of power received is stable.

5. A power transmission device comprising
a power transmission unit for transmitting wireless power to a plurality of electronic devices,
a control unit for determining transmission information relating to the transmission of the wireless power to each electronic device of the plurality of electronic devices, and
a communication unit for sending a notification to prompt movement to the plurality of electronic devices according to the transmission information.

6. A power transmission system comprising
a power transmission device for transmitting wireless power, and
an electronic device for receiving wireless power from the power transmission device, and for providing a notification to prompt movement of the electronic device according to an amount of wireless power received.

7. An electronic device comprising:
an antenna configured to receive wireless power;
a rectifier circuit configured to convert the received wireless power to DC power;
a processor configured to determine an amount of power received by the antenna, and
at least one of a speaker, a vibrator, and a display device configured to provide a notification to prompt movement of the electronic device according to the amount of power received.

8. The electronic device according to claim 7, wherein
the processor determines whether the amount of power received is less than a predetermined threshold, and
the at least one of a speaker, a vibrator, and a display device provides the notification when the amount of power received is less than the predetermined threshold.

9. The electronic device according to claim 8, wherein
the antenna communicates with a power transmission device that transmits the wireless power, and obtains information relating to an amount of power transmitted from the power transmission device to the electronic device, and
the predetermined threshold is determined based on the amount of power transmitted.

10. The electronic device according to claim 7, wherein the processor performs the determination when the amount of power received is stable.
